(19) United States
(12) Patent Application Publication
(10) Pub. No.: US 2004/0008431 A1
(43) Pub. Date: Jan. 15, 2004

(54) Light collection member with a reflection part

(76) Inventor: Ann-Lun Lee, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/462,860

(22) Filed: Jun. 17, 2003

(30) Foreign Application Priority Data
Jul. 11, 2002 (TW) 091132835

(51) Int. Cl. G02B 5/10

(52) U.S. Cl. 359/853

(57) ABSTRACT

A light collection member with a reflection part is installed on an optical chassis and at least includes a reflection piece in an elliptic columnar, wherein the reflection piece has a first focusing point and a second focusing point, and the second focusing point is about located on a scanning line on a document; a light source being used to supply the needed light beam for the scanning process; a light collection mask being used to cover the light source. The light collection mask has an opening. The opening is located on the first focusing point of the reflection piece. During the scanning process, the light beam emits from the opening and is focused onto the second focusing point on the scanning line, according to the focusing principle for an elliptic geometric shape. Wherein, the opening of the light collection mask can allow the emitted light beam to approach to a point light source, so as to further concentrate the focusing area on the scanning line, and to improve the light collection efficiency of the reflection piece.

This application claims the benefit of Taiwan application Serial No. 91132835, filed Nov. 7, 2002.

### BACKGROUND OF THE INVENTION

1. Field of the Invention

The present invention relates to a light collection member with a reflection part, and more particularly, the present invention relates to a light collection member with a reflection part, which can collect the light beam twice.

2. Description of Related Art

Referring to FIG. 1, it is a drawing of cross-sectional view, schematically illustrating a conventional optical chassis for a flatbed scanner. The optical chassis 110 is implemented with a light source 120. A reflection piece 130 in an elliptic columnar structure is disposed under the light source 120. Wherein, the light source 120 is located at the first focusing point 131 of the reflection piece 130, and the second focusing point 133 of the reflection piece 130 is about located at the scanning line 145 on the document 140. During the scanning operation, the light source 120 emits the light beam, such as the light beam 121 and the light beam 123. After a number of times of reflection on the reflection piece 130, which has the elliptic shape in cross sensing device (not shown in the drawing) inside the optical chassis 110, and then is converted into an electric signal for output.

Referring to FIG. 2, it is a drawing, schematically illustrating the mechanism for focusing the light beams as being applied in FIG. 1. Since the light source 120 has the larger area for emitting the light beams, after a number of times of reflection by the reflection piece 130, a rather larger focusing area 210 will be formed when the light beams are focused on the document 140 that is disposed on the second focusing point 133. In this situation, the light collection efficiency of the reflection piece 130 is reduced by a large amount. For the other point of view, the illumination efficiency of the light source 120 is also greatly reduced by a large amount. As a result, the quality of the scanning result is also greatly affected.

### SUMMARY OF THE INVENTION

It is therefore an objective of the present invention to provide a light collection member with a reflection part, which has been additionally implemented with a light collection mask for use with function of a second time of light collection. As a result, the original light source with a larger illumination area can be changed to approach a point light source, and then the reflection piece, which has the elliptic shape in the cross sectional view, can perform the focusing effect. The light beam emitted from the point light source can be focused on the document with a focusing area, which is also approaching to a point shape, so that the light beam illuminating on the document can be more concentrated, and whereby the light signal reflected into the optical chassis can be more precise. As a result, the light collection efficiency of the reflection piece not only can be improved but also the waste of resource can be prevented from occurring and the quality of the scanning result can be effectively improved.

In accordance with the foregoing and other objectives of the present invention, the invention provides a light collection member with a reflection part, including a reflection piece in an elliptic columnar, a light source, and a light collection mask. The reflection piece has a first focusing point and a second focusing point, wherein the second focusing point is about located on a scanning line on a document. The light source is used to supply the needed light beam for the scanning process. The light collection mask is used to cover the light source, and the light collection mask has an opening. The location of the opening is on the first focusing point of the reflection piece. During the scanning process, the light beam emits from the opening and is focused onto the second focusing point, which is on the scanning line, according to the focusing principle for an elliptic geometric shape.

### BRIEF DESCRIPTION OF DRAWINGS

The invention can be more fully understood by reading the following detailed description of the preferred embodiments, with reference made to the accompanying drawings, wherein:

FIG. 1 is a drawing of cross-sectional view, schematically illustrating a conventional optical chassis for a flatbed scanner;

FIG. 2 is a drawing, schematically illustrating the mechanism for focusing the light beams as being applied in FIG. 1;

FIG. 3 is a drawing of cross-sectional view, schematically illustrating an optical chassis for a scanner, according to a preferred embodiment of the present invention; and

FIG. 4 is a drawing, schematically illustrating the mechanism for focusing the light beams as being applied in FIG. 3.

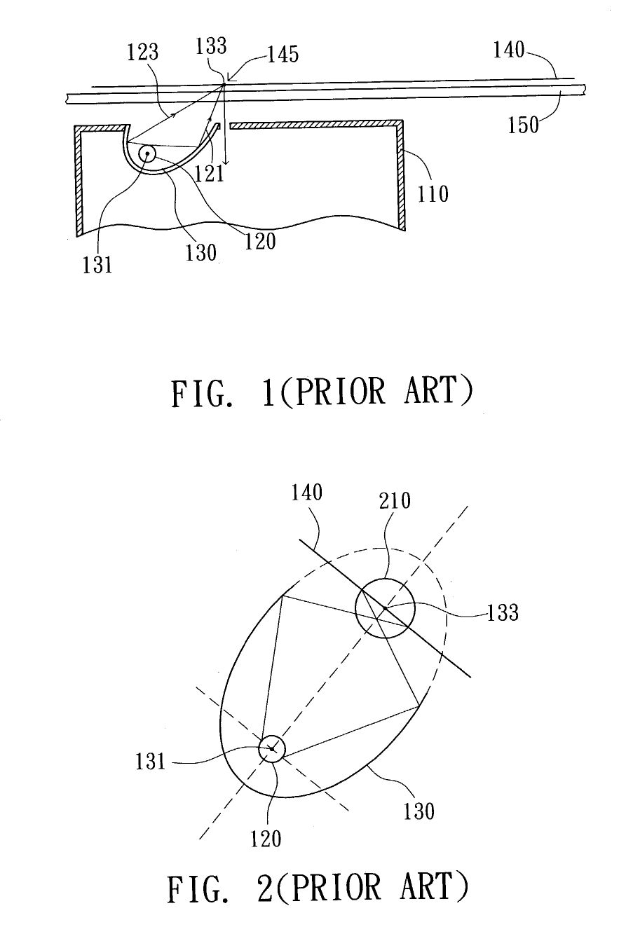

### DETAILED DESCRIPTION OF PREFERRED EMBODIMENTS

The light collection member with the reflection piece of the present invention is additionally implemented with a light collection mask, so as is to allow the light source can perform illumination by approaching to a point light source, in which the new produced light source is located again on a first focusing point of the reflection piece, so that the light beam focused on the second focusing point can be better concentrated.

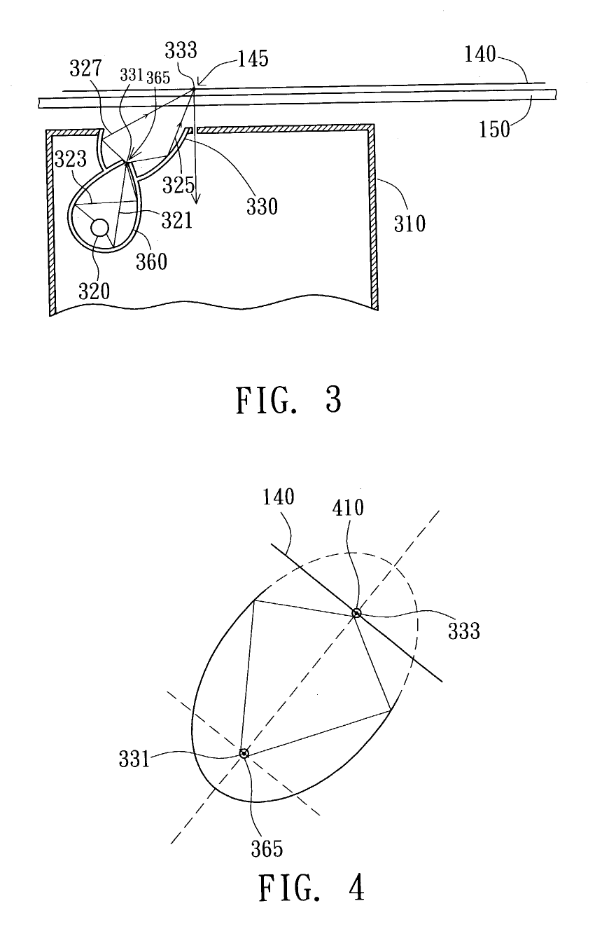

Referring to FIG. 3, it is a drawing of cross-sectional view, schematically illustrating an optical chassis for a scanner, according to a preferred embodiment of the present invention. The light collection mask 360 is used to cover the light source 320 in an enclosing manner, so that no matter how the light beam emitted from the light source 320, such as the light beam 321 or the light beam 323, is reflected in the light collection mask 360, the light beam at the end will emit from the opening 365 of the light collection mask 360. Since the aperture of the opening 365 is much smaller the aperture of the light source 320, this would cause the behavior for the emitted light beam will approach to a point light source. In addition to this, the opening 365 is further located on the first focusing point 331 of the reflection piece 330 in an elliptic columnar structure. Since the light beam, such as the light beam 325 or the light beam 327, which is emitted from the opening 365, has been reflected by the reflection piece 330 made from the metallic material, the light beam can be focused onto the second focusing point 333 that is located on the scanning line of the document 140.

Referring to FIG. 4 at the same time, it is a drawing, schematically illustrating the mechanism for focusing the light beams as being applied in FIG. 3. According to the focusing principle for an elliptic geometric shape, the light beam emitted from the opening 365, which is located at the first focusing point 331, is approaching to a point light source and will be focused onto the second focusing point 333, so that the focusing area 410 on the document 140 is also approaching to a spot shape. By this manner, the light collection efficiency of the reflection piece 330 and the illumination efficiency of the light source 320 can be effectively improved, and that the quality of scanning result can be further improved.

Wherein, since the opening 365 has the effect for secondary collection of the light beam, the light source 320 will not be restricted to use the line light source, which is conventionally used, the light source can also be composed of a number of point light sources, such as a number of point-like. lamps. The light collection mask 360 is made of metallic material or the material having high reflectivity, such as the white paper with a smooth surface without light transmission.

It should be mention that in order to prevent the light beam, which is emitted from the light source 320, from being reflected by mask wall of the light collection mask 360 back into the surface of the light source, and causing the light energy to be absorbed by the light source 320, the light collection mask 360 preferably is a columnar structure having the shape structure of water drop or circle, and so on, in the cross sectional view with a large crossing area.

In conclusions, the present invention has disclosed the light collection member with the reflection piece as described in the foregoing embodiments, which has been additionally implemented with a light collection mask for use with function of a second time of light collection. As a result, the 15 original light source with a larger illumination area can be changed to approach a point light source, and then the reflection piece, which has the elliptic shape in the cross sectional view, can perform the focusing effect. By this manner, the light collection efficiency of the reflection piece can be effectively improved. From the other point of view, the illumination efficiency of the light source is also greatly improved. This can prevent the resources from being wasted and the quality of the scanning results can be greatly improved.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A light collection member with a reflection part, implemented on an optical chassis of an image forming device, wherein the device is used to scan a document, the light collection member with a reflection part at least comprising:
a reflection piece, being an elliptic columnar structure and having a first focusing point and a second focusing point, wherein the second focusing point is about located on a scan line of the document;
a light source, being used to supply a needed light beam for the scanning operation; and
a light collection mask, being used to cover the light source, and having an opening, wherein the opening is located on the first focusing point,
wherein, when a scanning process is proceeding, the light beam emits from the opening, and since the opening is located on the first focusing point, the light beam emitted from the first focusing point is focused onto the second focusing point, according to a focusing principle with respect to an elliptic geometry shape, that is, the light beam is focused on the scan line.

2. The light collection member with the reflection part as recited in claim 1, wherein the reflection piece is made of a metallic material.

3. The light collection member with the reflection part as recited in claim 1, wherein the light source is a line light source.

4. The light collection member with the reflection part as recited in claim 1, wherein the light source is composed of a plurality of point light sources.

5. The light collection member with the reflection part as recited in claim 1, wherein the light collection mask covers the light source by an enclosing manner, and only allows the light beam to emit out through the opening.

6. The light collection member with the reflection part as recited in claim 1, wherein an aperture of the opening is much smaller than an aperture of the light source.

7. The light collection member with the reflection part as recited in claim 1, wherein the light collection mask includes a material with high reflectivity.

8. The light collection member with the reflection part as recited in claim 1, wherein the light collection mask includes a metallic material.

9. The light collection member with the reflection part as recited in claim 7, wherein the light collection mask includes a material of white paper with a smooth inner surface without light transmission.

10. The light collection member with the reflection part as recited in claim 7, wherein the light collection mask includes a structure of water drop in a cross sectional view.

11. The light collection member with the reflection part as recited in claim 7, wherein the light collection mask includes a structure of circle. in a cross sectional view.

12. A light collection member with a reflection part, implemented on an optical chassis of an image forming device, wherein the device is used to scan a document, the optical chassis is implemented with a light source and a reflection piece, wherein the reflection piece is an elliptic columnar having a first focusing point and a second focusing point, so that the reflection piece can allow a light beam emitted from the first focusing point to be focused onto the document at the second focusing point, the characteristics of the light collection member with a reflection part comprising:
a light collection mask, which is additionally implemented to cover the light source, and has an opening, wherein the opening is located on the first focusing point, the light beam emits from the light source is reflected by the light collection mask for a plurality of times, and then emits out from the opening, as well as the light beam is again reflected by the light collection mask to focus onto the document at the second focusing point.
